(19) United States
(12) Patent Application Publication
(10) Pub. No.: US 2007/0135324 A1
(43) Pub. Date: Jun. 14, 2007

(54) Fungicidal microemulsion

(76) Inventors: Kyung-Goo Kang, Daejeon (KR); Dal-Soo Kim, Daejeon (KR); Sam-Jae Chun, Daejeon (KR); Sang-Who Lee, Daejeon (KR); Goon-Ho Ioe, Daejeon (KR)

Correspondence Address: BIRCH STEWART KOLASCH & BIRCH, PO BOX 747, FALLS CHURCH, VA, 22040-0747, US

(21) Appl. No.: 10/578,334

(22) PCT Filed: Nov. 4, 2004
(86) PCT No.: PCT/KR04/02838

§ 371 Date: May 4, 2006

(30) Foreign Application Priority Data
Nov. 5, 2003 (KR) 10-2003-0077854

(51) Int. Cl. C11D 17/00

(52) U.S. Cl. 510/407

(57) ABSTRACT

The present invention relates to a stable microemulsion composition comprising metalaxyl-M(methyl N-(methoxyacetyl)N-(2,6-xylyl)-D-alaninate) used for agricultural fungicide as active ingredient. Specifically, the microemulsion composition of the present invention is characterized in that the phase is not destroyed at a wide range of temperature during storage to remain stable, even if the composition comprises a high concentration of active ingredient. Also, the microemulsion composition of the present invention can form stable microemulsion in a wide range of dilution concentration, even if the composition is diluted with water.

### TECHNICAL FIELD

The present invention relates to a stable microemulsion composition comprising metalaxyl-M(methyl N-(methoxyacetyl)-N-(2,6-xylyl)-D-alaninate) and a method for controlling plant disease using the above composition. Specifically, the present invention relates to a stable microemulsion composition which essentially comprises polyoxyalkylene tristyrylphenyl ether as emulsifier, and further comprises one or more selected from calcium salt of alkylbenzene sulfonic acid and sodium salt of dialkyl succinic acid, appropriate aqueous solvent which is not water insoluble solvent, and water, or aqueous pigment, and a method for controlling plant disease using the above composition.

### BACKGROUND ART

Recently, the problems of toxicity to the human body and environmental pollution by agricultural chemical have became grave issues, and thus securing safety for human and environment has become an essential factor as precondition for development of agricultural chemical formulation. Thus, it has been a recent trend to try to improve safety for human and environment through solving dust problem by granulation or developing preparation using such safe solvent as water.

Specifically, still widely used emulsion concentrate uses a large quantity of water insoluble organic solvent, which could give poisonous effect to the human body and environment. Thus, its substitution is urgently needed. From this point of view, the development of preparation comprising such nontoxic or stable solvent as water, instead of such insoluble solvent as existing emulsion concentrate, has been a very important issue with respect to providing the manufacturer with economic profit through image improvement in the long run in fulfilling social responsibility as well as reducing the poisons effect of the composition.

The solvent used in various solution preparations including emulsion concentrate should be selected by considering physical and chemical properties such as volatilization and inflammability as well as toxicity. The safety of solvent used for agrochemical preparation in terms of toxicity is easily measured by whether the solvent is permitted to use for the human body such as cosmetics, medicine, or food. In this regard, the agrochemical composition prepared by using solvent such as water and glycols which can be used as additive in medicine and cosmetic has advantage in terms of toxicity, compared with the agrochemical composition comprising water insoluble solvent.

A large number of patent applications relating to microemulsion preparation for agrochemical have been filed. For example, PCT patent laid open publication, WO 99/65300, disclosed an aqueous based microemulsion composition comprising pyrethroids as active ingredient without containing polyoxyethylene nonylphenyl ether. U.S. Pat. No. 5,227,402 disclosed a microemulsion composition stable at high temperature by mixed use of phosphate of polyoxyethylene tristyrylphenyl ether and various non-phosphorylated emulsifiers. U.S. Pat. No. 5,326,789 disclosed an aqueous microemulsions comprising an active triazole fungicide such as penconazole, a solvent such as alkylpyrrolidone, and a surfactant mixture such as salt of dodecyl sulfate and polyoxyethylene nonylphenyl ether. U.S. Pat. No. 6,369,001 disclosed a microemulsion composition containing both water-based and oil-based agrochemical such as glyphosate of water soluble agrochemical and quizalofop-P-ethyl of water insoluble agrochemical, at the same time.

Several patent applications relating to the fungicidal active ingredient, metalaxyl-M, used in the present invention have been filed. For example, U.S. Pat. No. 6,274,570 disclosed a concentrated emulsion composition of metalaxyl-M, comprising emulsifier such as polyoxyethylene castor oil, polyoxyethylene isotridecyl ether, and polyoxyethylene tristyrylphenyl ether; and water soluble and water insoluble organic solvent such as γ-butyllactone and fatty acid methyl ester, with using relatively excessive amount of surfactant and organic solvent. Also, U.S. Pat. No. 6,071,857 disclosed a concentrated emulsion composition of metalaxyl-M, comprising mixture of butanol-ethoxylate-propoxylate block copolymer and polyoxyethylene tristyrylphenyl ether as emulsifier, and γ-butyllactone and fatty acid methyl ester as organic solvent.

However, the above emulsion concentrate compositions containing metalaxyl-M as active agrochemical ingredient in U.S. Pat. No. 6,274,570 and U.S. Pat. No. 6,071,857 consist of only emulsifier and solvent except the active ingredient. The above emulsion concentrate compositions use a mixture of both water soluble solvent and water insoluble solvent. This mixture of solvent is used to dissolve metalaxyl-M in the preparation process of the composition of metalaxyl-M, and to emulsify metalaxyl-M in the water dilution process which is an essential step in controlling plant disease by using the composition. Thus, the emulsion concentrate composition of active metalaxyl-M can be easily expected to have drawback in view of toxicity, compared with the microemulsion composition of the present invention comprising water and water soluble solvent. The composition comprising metalaxyl-M can be prepared to liquid formulation besides emulsion concentrate. However, an excessive amount of solvent should be used enough to dissolve metalaxyl-M for the liquid composition, differently from microemulsion composition, because metalaxyl-M should be completely dissolved in the solvent in the liquid composition without surfactant. In the microemulsion composition of the present invention, metalaxyl-M is immiscible with water to separate phase or to be emulsified if appropriate emulsifier is not used. Therefore, the microemulsion composition comprising metalaxyl-M according to the present invention is characterized in forming a different form of microemulsion from emulsion or dissolution, within the composition and in case of diluting in water, differently from emulsion concentrate or liquid formulation, and thus is advantageous in forming a stable composition even if the amount of solvent used is relatively less than that of emulsion concentrate and liquid formulation.

The present inventors confirmed that the microemulsion composition comprising metalaxyl-M can be prepared by using nontoxic water and water-soluble solvent, differently from the emulsion concentrate using only organic solvent without water, and prepared a stable highly concentrated microemulsion composition having storage stability at a wide range of temperature condition and a long term water dilution stability. It was further confirmed that the stable microemulsion composition having metalaxyl-M as active ingredient can be prepared when specific emulsifier mixture and specific water soluble solvent are used. This, fungicidal composition was prepared by adding appropriate emulsifier mixture, aqueous solvent, and water, or further aqueous pigment into active ingredient, metalaxyl-M, and the composition's storage stability and water dilution stability were evaluated. Based on the result, the present invention was completed.

### DISCLOSURE OF THE INVENTION

The present invention provides an environment-friendly and less toxic microemulsion composition by using aqueous solvent and water in the preparation of metalaxyl-M used as agricultural fungicide.

Also, the present invention provides a stable microemulsion composition comprising metalaxyl-M which solves the problems of storage stability and dilution stability that are the biggest obstacle in commercializing microemulsion as agrochemical preparation.

Moreover, the present invention provides an economical microemulsion composition having storage stability at a wide range of temperature, though relatively lower concentration of emulsifier is added, even in case of preparing microemulsion having high concentration of metalaxyl-M. Further, the present invention provides a stable and practical microemulsion composition, even when used for controlling plant disease because the active ingredient is not precipitated for a long time in case of diluting with water, and a method for controlling plant disease by using the composition.

### BEST MODE FOR CARRYING OUT THE INVENTION

The present invention relates to a microemulsion composition for controlling plant disease, comprising metalaxyl-M(methyl N-(methoxyacetyl)-N-(2,6-xylyl)-D-alaninate) of the following formula (1), appropriate mixture of emulsifiers, appropriate aqueous solvent, and water, or additionally aqueous pigment.

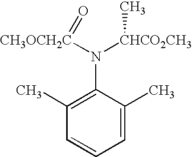

In the present invention, the object to maintain the physical and chemical stability during storage, and the dilution stability in case of diluting with water, of the microemulsion composition having metalaxyl-M as active ingredient was solved by using appropriate aqueous solvent and appropriate mixture of emulsifiers.

The emulsifier which may be used for the present invention essentially comprises polyoxyalkylene tristyrylphenyl ether, and further comprises one or more selected from calcium salt of alkylbenzene sulfonic acid and sodium salt of dialkyl succinic acid.

The polyoxyalkylene tristyrylphenyl ether which may be used for the present invention is polyoxyethylene tristyrylphenyl ether or polyoxyethylene/polyoxypropylene tristyrylphenyl ether. In case of polyoxyethylene tristyrylphenyl ether, the average added mole number of ethyleneoxide is 10 to 40 moles, preferably 15 to 30 moles, more preferably 17 to 30 moles. In case of polyoxyethylene/polyoxypropylene tristyrylphenyl ether, the average added mole number of ethyleneoxide is 15 to 40 moles and the average added mole number of propyleneoxide is 1 to 10 moles; preferably, the average added mole number of ethyleneoxide is 15 to 35 moles and the average added mole number of propyleneoxide is 1 to 5 moles; more preferably, the average added mole number of ethyleneoxide is 20 to 35 moles and the average added mole number of propyleneoxide is 1 to 3 moles.

The polyoxyalkylene tristyrylphenyl ether which is used in the Example of the present invention is KONION TSP200, KONION TSP290, and KONION TSP1520R (Green Softchem, Korea), in which products styryl group has been added by 2.5 to 3 moles on average to phenyl group. In case of KONION TSP200, the average added mole number of ethyleneoxide is about 18.5 moles, and in case of KONION TSP290, the average added mole number of ethyleneoxide is about 27 moles. In KONION TSP1520R, a polymer which ethyleneoxide and propyleneoxideis are randomly added, the average added mole number of ethyleneoxide is about 29 moles, and the average added mole number of propyleneoxide is about 3 moles. In KONION TSP100, which is used in the comparative Example of the present invention, the average added mole number of ethyleneoxide is about 9.2 moles.

The calcium salt of alkylbenzene sulfonic acid, which may be used in the present invention, is proper when alkyl group has the carbon number of about 9 to 15, and straight or branched chain. The preferable calcium salt of alkylbenzene sulfonic acid is calcium salt of dodecylbenzene sulfonic acid wherein alkyl group is dodecyl group.

Calcium salt of alkylbenzene sulfonic acid, which is used in the Example of the present invention, is BC2070M (Tayca Corp., Japan) comprising 70% of calcium salt of dodecylbenzene sulfonic acid as effective ingredient and the rest of isobutanol. The alkyl group of the above effective ingredient has branched chain.

Sodium salt of dialkyl succinic acid, which may be used in the present invention, is proper when the carbon number of alkyl group is 8 to 9, and the preferable sodium salt of dialkyl succinic acid is sodium salt of di(2-ethylhexyl) succinic acid.

Sodium salt of dialkyl succinic acid which is used in the Example of the present invention is EMPIMIN OP70 (Huntsman, English) comprising 70% of sodium salt of di(2-ethylhexyl) succinic acid and the rest of propyleneglycol.

The aqueous solvent which may be used in the present invention is glycol such as propyleneglycol, ethyleneglycol, diethyleneglycol, dipropyleneglycol, tripropyleneglycol, etc.; alcohol such as methanol, ethanol, isopropanol, normal propanol, tetrahydroperfurylalcohol, etc.; lactone and pyrrolidone such as N-methyl-2-pyrrolidone, γ-butyl lactone, etc.; glycol ether such as propyleneglycol monomethylether, diethyleneglycol monobutyl ether, dipropyleneglycol monomethylether, triethyleneglycol monobutylether, etc.; amine such as triethanolamine, etc.; and amide such as N,N-dimethylformamide, N,N-dimethylacetamide, etc. Only, the storage stability and dilution stability, which are the object of the present invention, can be secured by using the aqueous solvent, but considering toxicity of the aqueous solvent, propyleneglycol, ethanol, isopropanol, or normal propanol is preferably used, and propyleneglycol is more preferably used. The comparison of relative toxicity of aqueous solvent can be easily evaluated by referring to articles such as “List of other Pesticide Ingredients” provided by U.S. Environment Protection Agency, etc.

Among the solvents which are used in the Example and Comparative Example of the present invention, diethyleneglycol monobutyl ether is HY-BDG (Han Nong Chemicals, Inc., Korea), dipropyleneglycol monomethylether is HY-MFDG, triethyleneglycol monobutylether is HY-BTG, propyleneglycol monomethylether is HY-MFG, tripropyleneglycol is HY-TPG, dipropyleneglycol is HY-DPG, and the rest solvents are purchased from Aldrich (USA) and Wako (Japan).

The aqueous pigment which may be used in the present invention is water soluble pigment having various color, and the edible pigment is preferable if toxicity is considered. The present microemulsion is characterized in being formed with very small particles through which light can be transmitted, and so looks transparent, when its composition is diluted with water. Thus, the present invention uses the aqueous pigment to distinguish the diluted condition by the naked eye.

The aqueous pigment, which is used in the Example of the present invention, is edible pigment (mixed green color) purchased from Bolak, Inc. (Korea).

The microemulsion composition of the present invention, which has outstanding storage and dilution stability, comprises metalaxyl of 10 to 70 weight %, preferably 20 to 60 weight %, more preferably 40 to 60 weight %; emulsifier of 5 to 50 weight %, preferably 10 to 30 weight %, more preferably 10 to 20 weight %; aqueous solvent of 5 to 50 weight %, preferably 10 to 30 weight %, more preferably 10 to 20 weight %; water of 5 to 50 weight %, preferably 20 to 40 weight; and aqueous pigment of 0 to 0.2 weight %. When metalaxyl-M is used less than 10 weight %, it is difficult to adjust the dilution ratio in case of using for economically controlling plant disease, and when metalaxyl-M is used more than 70 weight %, the preparation's viscosity becomes higher, and it is difficult to maintain the physical and chemical stability during storage.

The present invention also provides a method for controlling plant disease by using the composition according to the present invention. The composition according to the present invention is homogeneously diluted with water, and then sprayed by using appropriate sprayer, to control plant disease using the composition. The composition according to the present invention can be easily sprayed because the composition homogeneously maintains stable microemulsion phase at room temperature during at least 1 hr to 12 hr after dilution with water. When the microemulsion composition of the present invention is diluted with water, the concentration of the microemulsion composition may be adjusted to the range of 0.02 to 5%, preferably 0.1 to 2%, to make active ingredient, metalaxyl-M, be in biologically effective concentration.

The composition according to the present invention is effective for controlling diseases caused by the following pathogenic bacterium, but not limited thereto: Gerbera phytophthora root rot [pathogenic bacterium: Phytophthora cryptogea], late blight [pathogenic bacterium: Phytophthora infestans], phytophthora blight [pathogenic bacterium: Phytophthora capsici], tomato phytophthora root rot [pathogenic bacterium: Phytophthora infestans], tobacco phytophthora root rot [pathogenic bacterium: Phytophthora nicotianae var nicotianae], sesame phytophthora root rot [pathogenic bacterium: Phytophthora nicotianae var parasitica], apple phytophthora root rot [pathogenic bacterium: Phytophthora cactorum)], muskmelon downy mildew [pathogenic bacterium: Pseudoperonospora cubensis], melon downy mildew [pathogenic bacterium: Pseudoperonospora cubensis], cucumber downy mildew [pathogenic bacterium: Pseudoperonospora cubensis], celery cabbage downy mildew [pathogenic bacterium: Peronospora parasitica], rose downy mildew [pathogenic bacterium: Peronospora sparsa], grape downy mildew [pathogenic bacterium: Plasmopara vitiola], and hop downy mildew [pathogenic bacterium: Pseudoperonospora humuli].

The following examples are presented to illustrate further the present invention. However, it should be understood that these examples are intended to illustrate the present invention, and cannot limit the scope of the present invention in any way.

Preparations

Tables 1 and 2 show preparation examples of the microemulsion composition comprising metalaxyl-M according to the present invention.

The microemulsion composition of the present invention can be easily prepared by mixing active ingredient and supplementary materials and stirring the mixture with using appropriate mixer. Only, in order to reduce the preparation time, it is preferable to mix metalaxyl-M and aqueous solvent, and then to add emulsifier, water, and aqueous pigment in order with stirring. The percent (%) in the following tables means weight %.

TABLE 1

| | Preparations No. | | | | | | | | | | |
|---|---|---|---|---|---|---|---|---|---|---|---|
| | 1 | 2 | 3 | 4 | 5 | 6 | 7 | 8 | 9 | 10 | 11 |
| metalaxyl-M | 50% | 50% | 50% | 50% | 50% | 50% | 50% | 50% | 50% | 50% | 60% |
| BC2070M | 3% | 3% | 3% | 3% | 3% | 3% | 6% | 3% | 4% | — | 3% |
| EMPIMIN | — | — | — | — | — | — | — | — | — | 6% | — |
| OP70 | | | | | | | | | | | |
| KONION | 7% | 7% | 7% | 7% | 7% | 7% | 14% | — | — | — | 7% |
| TSP200 | | | | | | | | | | | |
| KONION | — | — | — | — | — | — | — | 7% | — | — | — |
| TSP290 | | | | | | | | | | | |
| KONION | — | — | — | — | — | — | — | — | 6% | 14% | — |
| TSP1520R | | | | | | | | | | | |
| propylene- | 10% | — | — | — | — | 20% | 10% | 10% | 10% | 20% | 10% |
| glycol | | | | | | | | | | | |
| N-methyl-2- | — | 10% | — | — | — | — | — | — | — | — | — |
| pyrrolidone | | | | | | | | | | | |
| ethanol | — | — | 10% | — | — | — | — | — | — | — | — |
| iso-propanol | — | — | — | 10% | — | — | — | — | — | — | — |
| N,N-dimethyl | — | — | — | — | 10% | — | — | — | — | — | — |
| formamide | | | | | | | | | | | |
| edible pigment | 0.05% | 0.05% | 0.05% | 0.05% | 0.05% | 0.05% | 0.05% | 0.05% | 0.05% | 0.05% | 0.05% |
| (mixed green | | | | | | | | | | | |
| color) | | | | | | | | | | | |
| distilled | surplus | surplus | surplus | surplus | surplus | surplus | surplus | surplus | surplus | surplus | surplus |
| water | | | | | | | | | | | |
| Total Sum | 100% | 100% | 100% | 100% | 100% | 100% | 100% | 100% | 100% | 100% | 100% |

TABLE 2

| | Preparations No. | | | | | | | | | | |
|---|---|---|---|---|---|---|---|---|---|---|---|
| | 12 | 13 | 14 | 15 | 16 | 17 | 18 | 19 | 20 | 21 | 22 |
| metalaxyl-M | 50% | 50% | 50% | 50% | 50% | 50% | 50% | 50% | 50% | 50% | 50% |
| BC2070M | 3% | 3% | 3% | 3% | 3% | 3% | 3% | 3% | 3% | 3% | 3% |
| KONION | 7% | 7% | 7% | 7% | 7% | 7% | 7% | 7% | 7% | 7% | 7% |
| TSP200 | | | | | | | | | | | |
| tetrahydroper- | 20% | — | — | — | — | — | — | — | — | — | — |
| furyl alcohol | | | | | | | | | | | |
| normal propanol | — | 20% | — | — | — | — | — | — | — | — | — |
| ethyleneglycol | — | — | 20% | — | — | — | — | — | — | — | — |
| HY-DPG | — | — | — | 20% | — | — | — | — | — | — | — |
| HY-TPG | — | — | — | — | 20% | — | — | — | — | — | — |
| HY-MFG | — | — | — | — | — | 20% | — | — | — | — | — |
| HY-BTG | — | — | — | | — | — | 20% | — | — | — | — |
| HY-BDG | — | — | — | — | — | — | — | 20% | — | — | — |
| HY-MFDG | — | — | — | — | — | — | — | — | 20% | — | — |
| γ-butyllactone | — | — | — | — | — | — | — | — | — | 20% | — |
| triethanolamine | — | — | — | — | — | — | — | — | — | — | 20% |
| edible pigment | 0.05% | 0.05% | 0.05% | 0.05% | 0.05% | 0.05% | 0.05% | 0.05% | 0.05% | 0.05% | 0.05% |
| (mixed green | | | | | | | | | | | |
| color) | | | | | | | | | | | |
| distilled water | surplus | surplus | surplus | surplus | surplus | surplus | surplus | surplus | surplus | surplus | surplus |
| Total Sum | 100% | 100% | 100% | 100% | 100% | 100% | 100% | 100% | 100% | 100% | 100% |

### Comparative Preparation Example

Table 3 shows the comparative preparation example of the microemulsion composition comprising metalaxyl-M. The comparative preparation example of the present invention is prepared by the same method as the preparation example.

TABLE 3

| | Comparative Preparations No. | | | | |
|---|---|---|---|---|---|
| | 1 | 2 | 3 | 4 | 5 |
| metalaxyl-M | 50% | 50% | 50% | 50% | 50% |
| BC2070M | 3% | 3% | 3% | — | 3% |
| KONION | 7% | 7% | 7% | 10% | — |
| TSP200 | | | | | |
| KONION | — | — | — | — | 7% |
| TSP100 | | | | | |
| propylene- | — | — | — | 10% | 10% |
| glycol | | | | | |
| γ-butyl- | — | — | 10% | — | — |
| lactone | | | | | |
| oleic acid | 10% | 20% | 10% | — | — |
| methyl ester | | | | | |
| distilled | surplus | surplus | surplus | surplus | surplus |
| water | | | | | |
| Total Sum | 100% | 100% | 100% | 100% | 100% |

Test 1: Evaluation of Storage Stability of the Composition

The storage stability of the microemulsion composition comprising metalaxyl-M is evaluated by observing whether the microemulsion phase of the composition is destroyed during storage at a wide range of temperature condition. The storage stability is regarded as insufficient when the phase is destroyed and separated into two layers, or the composition is emulsified to milky color.

Each sample of preparation and comparative preparation was made by filling 50 ml of glass bottle with about 40 ml, and then its lid was closed. Each sample was stored at −10° C., 0° C., 25° C., 40° C., 54° C. (each±2° C. ) for 2 weeks, and then the appearance of each preparation sample was observed.

Tables 4, 5, and 6 show the result. The microemulsion of the preparation sample of the present invention was not destroyed and maintained transparent condition between −10° C. and 54° C. However, the microemulsion of the comparative preparation samples was destroyed to cause phase separation during storage between −10° C. and 54° C.

TABLE 4

| | Preparations No. | | | | | | | | | | |
|---|---|---|---|---|---|---|---|---|---|---|---|
| | 1 | 2 | 3 | 4 | 5 | 6 | 7 | 8 | 9 | 10 | 11 |
| −10° C. | clarity | clarity | clarity | clarity | clarity | clarity | clarity | clarity | clarity | clarity | clarity |
| 0° C. | clarity | clarity | clarity | clarity | clarity | clarity | clarity | clarity | clarity | clarity | clarity |
| 25° C. | clarity | clarity | clarity | clarity | clarity | clarity | clarity | clarity | clarity | clarity | clarity |
| 40° C. | clarity | clarity | clarity | clarity | clarity | clarity | clarity | clarity | clarity | clarity | clarity |
| 54° C. | clarity | clarity | clarity | clarity | clarity | clarity | clarity | clarity | clarity | clarity | clarity |

TABLE 5

| | Preparations No. | | | | | | | | | | |
|---|---|---|---|---|---|---|---|---|---|---|---|
| | 12 | 13 | 14 | 15 | 16 | 17 | 18 | 19 | 20 | 21 | 22 |
| −10° C. | clarity | clarity | clarity | clarity | clarity | clarity | clarity | clarity | clarity | clarity | clarity |
| 0° C. | clarity | clarity | clarity | clarity | clarity | clarity | clarity | clarity | clarity | clarity | clarity |
| 25° C. | clarity | clarity | clarity | clarity | clarity | clarity | clarity | clarity | clarity | clarity | clarity |
| 40° C. | clarity | clarity | clarity | clarity | clarity | clarity | clarity | clarity | clarity | clarity | clarity |
| 54° C. | clarity | clarity | clarity | clarity | clarity | clarity | clarity | clarity | clarity | clarity | clarity |

TABLE 6

| | Comparative Preparations No. | | | | |
|---|---|---|---|---|---|
| | 1 | 2 | 3 | 4 | 5 |
| −10° C. | separation | separation | separation | clarity | separation |
| 0° C. | clarity | separation | separation | clarity | separation |
| 25° C. | clarity | clarity | separation | clarity | separation |
| 40° C. | separation | separation | separation | separation | separation |
| 54° C. | separation | separation | separation | separation | separation |

Test 2: Evaluation of Dilution Stability of the Composition

The dilution stability of the microemulsion composition comprising metalaxyl-M is evaluated by observing whether the microemulsion phase is maintained for a certain period of time that the composition is diluted with water, in terms of phase separation, deposition of active ingredient, or formation of precipitation or cream. The dilution stability is regarded as insufficient when the phase is destroyed and separated, or precipitation or cream is formed.

The temperature condition to evaluate the dilution stability after diluting the composition of the present example with water was 10° C. and 25° C., considering the condition of temperature change wherein the composition is actually sprayed. The CIPAC Standard water D was prepared and used to adjust the degree of hardness. Considering various conditions during spraying, the dilution solutions whose dilution concentrations are 0.1% (vol/vol), 0.4% (vol/vol), and 1% (vol/vol) were prepared, and slightly shaken to mix the microemulsion composition and water. The dilution solutions were observed by the naked eye after 24 hr from the preparation.

Tables 7 and 8 show the result. The dilution solutions maintained the microemulsion phases after 24 hr in all the samples of Preparations without any phase destruction. The dilution stability of the comparative preparation was not evaluated since the phase separation went too far in the result of the storage stability test.

TABLE 7

| | dilution | Preparation No. | | | | | | | | | | |
|---|---|---|---|---|---|---|---|---|---|---|---|---|
| Temp. | Con. | 1 | 2 | 3 | 4 | 5 | 6 | 7 | 8 | 9 | 10 | 11 |
| 10° C. | 0.1% | clarity | clarity | clarity | clarity | clarity | clarity | clarity | clarity | clarity | clarity | clarity |
| | 0.4% | clarity | clarity | clarity | clarity | clarity | clarity | clarity | clarity | clarity | clarity | clarity |
| | 1% | clarity | clarity | clarity | clarity | clarity | clarity | clarity | clarity | clarity | clarity | clarity |
| 25° C. | 0.1% | clarity | clarity | clarity | clarity | clarity | clarity | clarity | clarity | clarity | clarity | clarity |
| | 0.4% | clarity | clarity | clarity | clarity | clarity | clarity | clarity | clarity | clarity | clarity | clarity |
| | 1% | clarity | clarity | clarity | clarity | clarity | clarity | clarity | clarity | clarity | clarity | clarity |

TABLE 8

| | dilution | Preparation No. | | | | | | | | | | |
|---|---|---|---|---|---|---|---|---|---|---|---|---|
| Temp. | Con. | 12 | 13 | 14 | 15 | 16 | 17 | 18 | 19 | 20 | 21 | 22 |
| 10° C. | 0.1% | clarity | clarity | clarity | clarity | clarity | clarity | clarity | clarity | clarity | clarity | clarity |
| | 0.4% | clarity | clarity | clarity | clarity | clarity | clarity | clarity | clarity | clarity | clarity | clarity |
| | 1% | clarity | clarity | clarity | clarity | clarity | clarity | clarity | clarity | clarity | clarity | clarity |
| 25° C. | 0.1% | clarity | clarity | clarity | clarity | clarity | clarity | clarity | clarity | clarity | clarity | clarity |
| | 0.4% | clarity | clarity | clarity | clarity | clarity | clarity | clarity | clarity | clarity | clarity | clarity |
| | 1% | clarity | clarity | clarity | clarity | clarity | clarity | clarity | clarity | clarity | clarity | clarity |

Generally, a microemulsion composition comprising agricultural chemical as active ingredient has advantage in view of biological activity due to the small particle size. Also, the microemulsion composition uses water, and so has higher safety and simpler preparation process than the composition having a large amount of water insoluble organic solvent.

However, in the microemulsion composition comprising agricultural chemical as active ingredient, the phase may be frequently destroyed or separated according to temperature change during storage. Also, the microemulsion may be destroyed to separate the phase, or the active ingredient may be precipitated, when the composition is diluted with water. Further, the microemulsion composition has drawbacks that it is difficult to prepare the composition having high concentration in most cases, and that its preparation cost is higher than conventional emulsion concentrate's because it needs more emulsifier than conventional emulsion concentrate to maintain the physical and chemical stability of the composition.

The microemulsion composition comprising metalaxyl-M according to the present invention has outstanding storage stability at a wide range of temperature condition even though the composition was prepared in high concentration, and outstanding dilution stability with water at a wide range of temperature condition. Also, the novel microemulsion composition comprising metalaxyl-M according to the present invention can me such lower toxic solvent as propyleneglycol, which is used for medicine or cosmetic, and so the present composition is expected to have less toxicity problem from supplementary materials than conventional emulsion concentrate.

Therefore, it is expected that the novel microemulsion composition comprising metalaxyl-M according to the present invention can be effectively commercialized in view of the economic aspect considering preparation cost, and the composition's stability considering toxicity, and used for controlling plant disease.

1. Microemulsion composition, essentially comprising metalaxyl-M as active ingredient and polyoxyalkylene tristyrylphenyl ether, and further comprising one or more emulsifier selected from the group consisting of calcium salt of alkylbenzene sulfonic acid and sodium salt dialkyl succinic acid; one or more aqueous solvents selected from the group consisting of lower alcohol, glycol, glycol ether, lactone, pyrrolidone, amine and amide; and water.

2. The composition according to claim 1, wherein the polyoxyalkylene tristyrylphenyl ether is polyoxyethylene tristyrylphenyl ether or polyoxyethylene/polyoxypropylene tristyrylphenyl ether, wherein the average added mole number of ethyleneoxide is 10 to 40 moles in case of the polyoxyethylene tristyrylphenyl ether, and wherein the average added mole number of ethyleneoxide is 15 to 40 moles and the average added mole number of propyleneoxide is 1 to 10 moles, in case of polyoxyethylene/polyoxypropylene tristyrylphenyl ether.

3. The composition according to claim 2, wherein the average added mole number of ethyleneoxide is 15 to 30 moles in case of the polyoxyethylene tristyrylphenyl ether, and wherein the average added mole number of ethyleneoxide is 15 to 35 moles and the average added mole number of propyleneoxide is 1 to 5 moles, in case of polyoxyethylene/polyoxypropylene tristyrylphenyl ether.

4. The composition according to claim 3, wherein the average added mole number of ethyleneoxide is 17 to 30 moles in case of the polyoxyethylene tristyrylphenyl ether, and wherein the average added mole number of ethyleneoxide is 20 to 30 moles and the average added mole number of propyleneoxide is 1 to 3 moles, in case of polyoxyethylene/polyoxypropylene tristyrylphenyl ether.

5. The composition according to claim 1, wherein the calcium salt of alkylbenzene sulfonic acid is calcium salt of dodecylbenzene sulfonic acid.

6. The composition according to claim 1, wherein the sodium salt of dialkyl succinic acid is sodium salt of di(2-ethylhexyl) succinic acid.

7. The composition according to claim 1, wherein the emulsifier is a mixture of polyoxyalkylene tristyrylphenyl ether and calcium salt of dodecylbenzene sulfonic acid.

8. The composition according to claim 1, wherein the emulsifier is a mixture of polyoxyalkylene tristyrylphenyl ether and sodium salt of di(2-ethylhexyl) succinic acid.

9. The composition according to claim 1, wherein the aqueous solvent is one or more selected from the group consisting of propyleneglycol, ethyleneglycol, diethyleneglycol, dipropyleneglycol, tripropyleneglycol, methanol, ethanol, isopropanol, normal propanol, tetrahydroperfuryl alcohol, N-methyl-2-pyrrolidone, γ-butyl lactone, propyleneglycol monomethylether, diethyleneglycol monobutyl ether, dipropyleneglycol monomethylether, triethyleneglycol monobutylether, triethanolamine, N,N-dimethylformamide, and N,N-dimethylacetamide.

10. The composition according to claim 9, wherein the aqueous solvent is one or more selected from the group consisting of propyleneglycol, ethanol, isopropanol, and normal propanol.

11. The composition according to claim 10, wherein the aqueous solvent is propyleneglycol.

12. The composition according to claim 1, wherein the ratio of metalaxyl-M is 10 to 70 weight %.

13. The composition according to claim 12, wherein the ratio of metalaxyl-M is 20 to 60 weight %.

14. The composition according to claim 13, wherein the ratio of metalaxyl-M is 40 to 60 weight %.

15. The composition according to claim 1, wherein the ratio of aqueous solvent is 5 to 50 weight %.

16. The composition according to claim 15, wherein the ratio of aqueous solvent is 10 to 30 weight %.

17. The composition according to claim 16, wherein the ratio of aqueous solvent is 10 to 20 weight %.

18. The composition according to claim 1, wherein the ratio of emulsifier is 5 to 50 weight %.

19. The composition according to claim 18, wherein the ratio of emulsifier is 10 to 30 weight %.

20. The composition according to claim 19, wherein the ratio of emulsifier is 10 to 20 weight %.

21. The composition according to claim 1, wherein the ratio of water is 5 to 50 weight %.

22. The composition according to claim 21, wherein the ratio of water is 20 to 40 weight %.

23. The composition according to claim 1, further comprising 0 to 0.2 weight % of aqueous pigment.

24. Microemulsion composition obtained by diluting the composition according to claim 1 with water.

25. Method for controlling plant disease, characterized in that the fungicidal composition according to claim 1 is applied to plant or habitat of pathogenic bacterium by diluting the composition with water in the biologically effective level.
